(19) United States
(12) Patent Application Publication
(10) Pub. No.: US 2016/0366929 A1
(43) Pub. Date: Dec. 22, 2016

(54) Method of Customizing a Vaping Composition

(71) Applicants: Mark Curtis Akers, Iuka, MS (US); Chaz Curtis Akers, Iuka, MS (US)

(72) Inventors: Mark Curtis Akers, Iuka, MS (US); Chaz Curtis Akers, Iuka, MS (US)

(21) Appl. No.: 15/188,539

(22) Filed: Jun. 21, 2016

Related U.S. Application Data
(60) Provisional application No. 62/183,089, filed on Jun. 22, 2015.

(51) Int. Cl. A24B 15/16; A24B 15/30; B65B 3/04; B01F 15/02; B01F 15/04; B01F 13/00; A24B 15/32; B01F 3/08

(52) U.S. Cl. CPC A24B 15/16; A24B 15/32; A24B 15/303; B01F 3/0803; B01F 15/0243; B01F 15/0491; B01F 13/0022; B65B 3/04

(57) ABSTRACT

A method of customizing a vaping composition enables the customization of liquid flavorings and a liquid vaping base to create a custom vaping composition. A volumetric concentration ratio between flavoring and vaping base is designated for a mixing bottle along with a flavor combination. At least one discrete quantity of liquid flavoring is expelled from each of the desired dispensers holding the liquid flavoring into the mixing bottle. An unmeasured quantity of liquid vaping base is expelled from a continuous dispenser into the mixing bottle until the designated volumetric concentration ratio between flavoring and vaping base is reached for the mixing bottle. The mixing bottle is then agitated to form a homogeneous vaping composition between the unmeasured quantity of liquid vaping base and the at least one discrete quantity of liquid flavoring from each of the desired dispensers.

The current application claims a priority to the U.S. Provisional Patent application Ser. No. 62/183,089 filed on Jun. 22, 2015.

### FIELD OF THE INVENTION

The present invention relates generally to a method for mixing a vaping composition. More specifically, the present invention is a method of customizing a vaping composition to achieve a desired concentration ratio between constituents of the composition.

### BACKGROUND OF THE INVENTION

An increasingly popular alternative to tobacco smoking is the use of personal vaporizing devices or vaporizers. Vaporizers are often utilized in smoking cessation as vaporizers are able to deliver an experience that is similar to smoking. The liquids utilized in vaporizers often contain nicotine in various concentrations that allow the user to slowly decrease the nicotine concentration while vaping over time. This is effective in smoking cessation as the user is able to vape at a high nicotine concentration in the immediate aftermath of quitting smoking cigarettes and gradually decrease or eliminate the nicotine concentration altogether over time. The liquids utilized for vaping typically consist of a mixture of propylene glycol (PG), vegetable glycerin (VG), liquid nicotine, and a flavoring. The specific ratios of these constituents may be adjusted to suit the user's desired vaping experience. For example, a high PG content mimics the “throat hit” sensation experienced when smoking a cigarette and as such, is often desired by ex-smokers. A high PG content additionally produces a smaller amount of vapor. Conversely, a high VG content results in a smoother feeling in the throat and additionally produces a larger amount of vapor. As previously discussed, the nicotine concentration may be adjusted to suit the user's needs as well. A wide variety of flavorings may be added to the composition including menthol flavorings, fruit flavorings, and candy flavorings.

The present invention is a method of customizing a vaping composition in order to achieve a desired concentration ratio between constituents of the composition. The present invention allows for the customization of the flavoring and the vaping base for the vaping composition. Within the context of the present invention, the vaping base relates generally to the PG and VG content of the vaping composition. The present invention additionally allows for the use of multiple flavorings within a single vaping composition.

### BRIEF DESCRIPTION OF THE DRAWINGS

FIG. 1A is a flowchart of the overall process that is followed by the present invention.

FIG. 1B is a continuation of the flowchart of the overall process that is followed by the present invention.

FIG. 2 is a flowchart of the secondary process that is followed by the present invention for the volumetric concentration ratio.

FIG. 3 is a flowchart of the secondary process that is followed by the present invention for the at least one discrete quantity of liquid flavoring.

FIG. 4 is a flowchart of the secondary process that is followed by the present invention when the total volume of the mixing bottle is 10 mL.

FIG. 5 is a flowchart of the secondary process that is followed by the present invention when agitating each of the desired dispensers.

FIG. 6 is a flowchart of the secondary process that is followed by the present invention when agitating the continuous dispenser.

FIG. 7 is a flowchart of the secondary process that is followed by the present invention when filling the mixing bottle with the unmeasured quantity of liquid vaping base.

FIG. 8 is a flowchart of the secondary process that is followed by the present invention when capping the mixing bottle.

FIG. 9 is a flowchart of the secondary process that is followed by the present invention when labeling the mixing bottle with the volumetric concentration ratio.

FIG. 10 is a flowchart of the secondary process that is followed by the present invention when labeling the mixing bottle with the set of compositional constituents.

FIG. 11 is a flowchart of the secondary process that is followed by the present invention when utilizing the plurality of shelves during the mixing process.

FIG. 12 is a flowchart of the secondary process that is followed by the present invention when utilizing the workstation table during the mixing process.

FIG. 13 is a flowchart of the secondary process that is followed by the present invention when utilizing a precision pump for each of the desired dispensers.

### DETAIL DESCRIPTIONS OF THE INVENTION

All illustrations of the drawings are for the purpose of describing selected versions of the present invention and are not intended to limit the scope of the present invention.

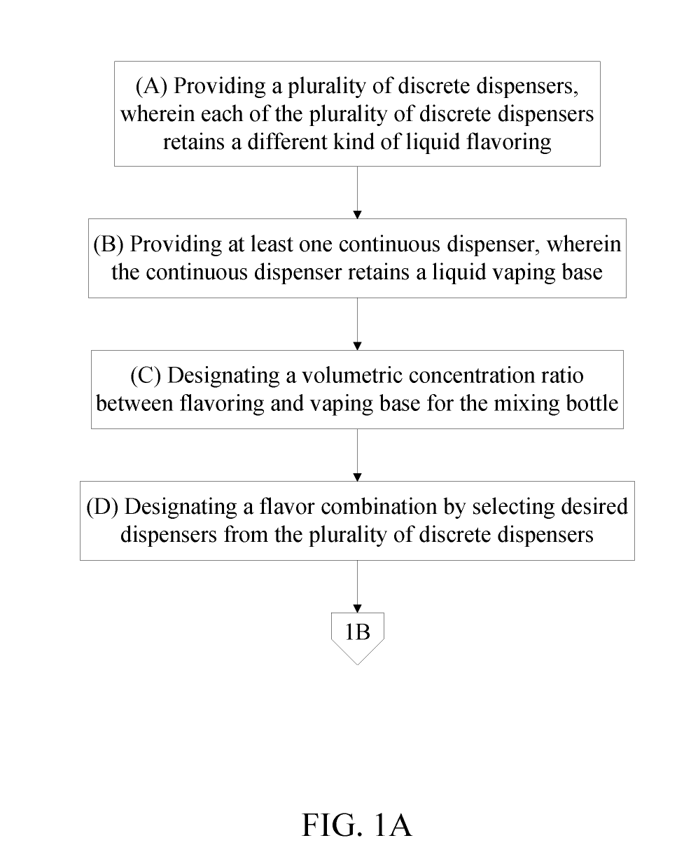

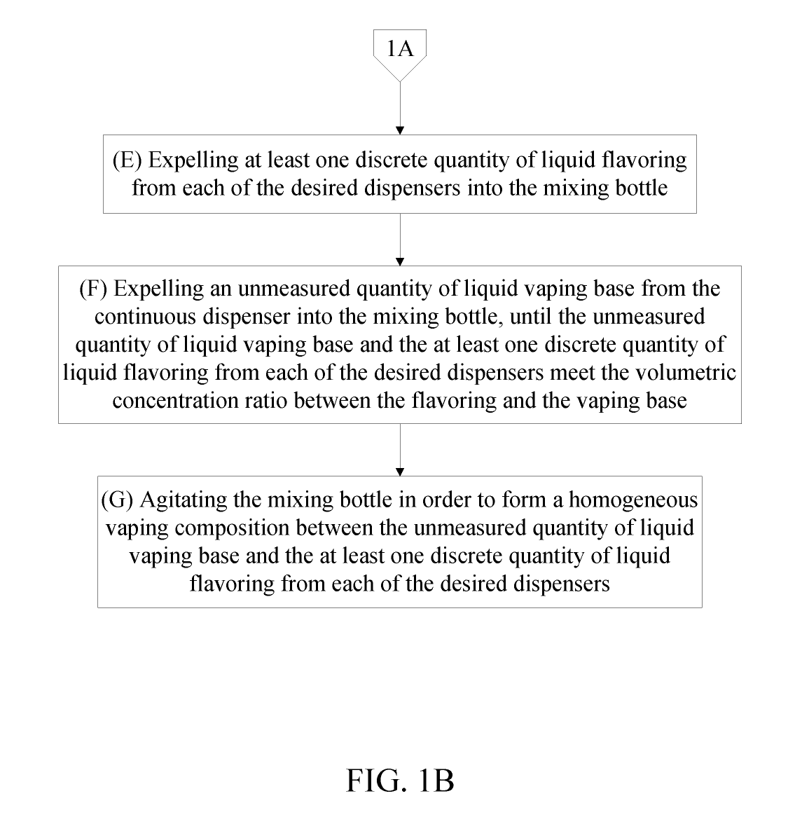

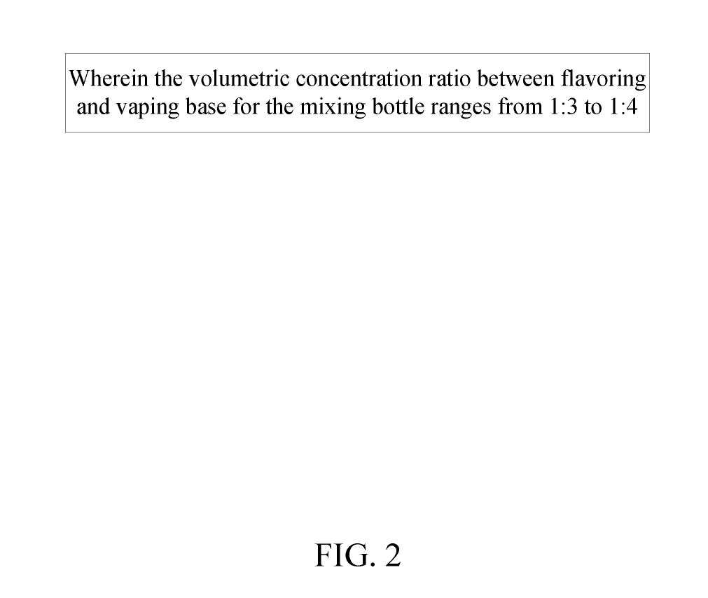

The present invention is a method of customizing a vaping composition in order to achieve a desired concentration ratio between constituents of the composition. The overall process followed by the present invention is shown in FIG. 1A and FIG. 1B while secondary processes followed by the present invention are shown in FIGS. 2-13.

With reference to FIG. 1A and FIG. 1B, a plurality of discrete dispensers is provided. The plurality of discrete dispensers serves as vessels for liquid flavorings and each of the plurality of discrete dispensers retains a different kind of liquid flavoring. At least one continuous dispenser is provided as well for retaining a liquid vaping base. In the preferred embodiment of the present invention, the liquid vaping base comprises propylene glycol (PG) and vegetable glycerin (VG).

With reference to the overall process described in FIG. 1A and FIG. 1B, a volumetric concentration ratio is designated between flavoring and liquid base for the mixing bottle. The mixing bottle is a vessel into which the liquid flavorings and the liquid vaping base are poured for mixing into the vaping composition. The volumetric concentration ratio relates generally to the proportion of the liquid flavorings and the liquid vaping base of the vaping composition. In the preferred embodiment of the present invention as shown in FIG. 2, the volumetric concentration ratio between flavoring and vaping base for the mixing bottle ranges from 1:3 to 1:4. The volumetric concentration ratio may be varied based on the desired strength of flavor for the vaping composition.

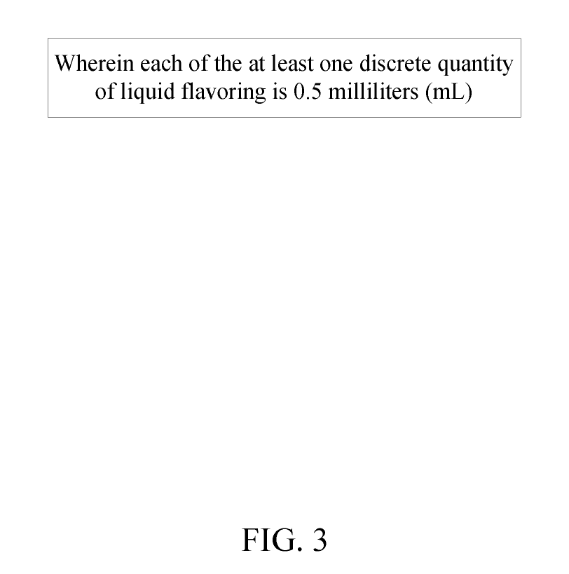

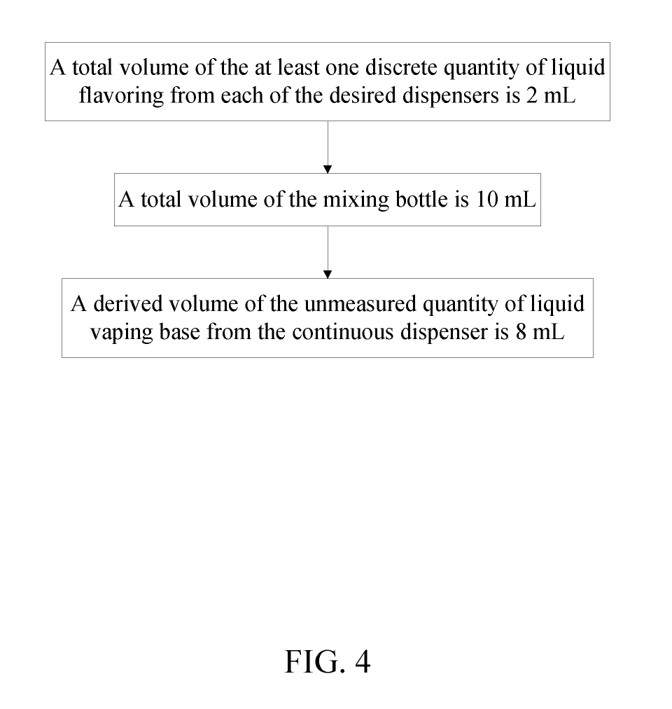

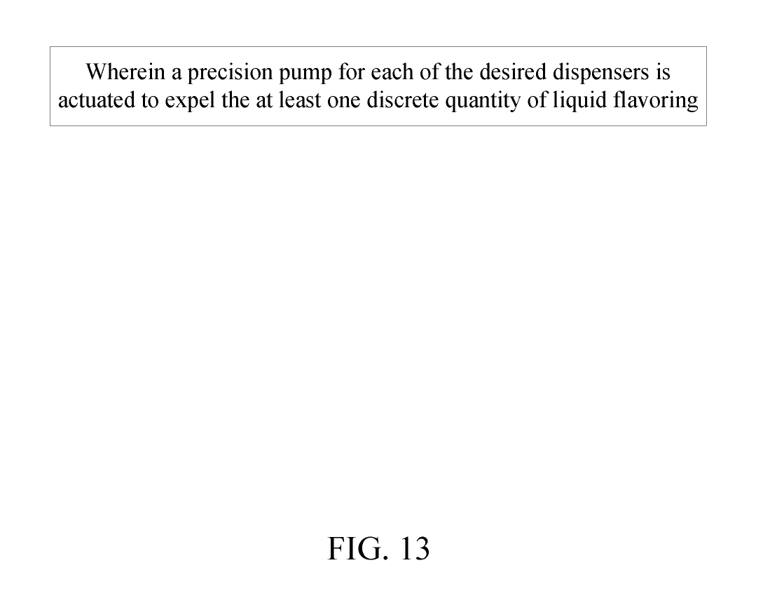

A flavor combination is designated by selecting desired dispensers from the plurality of discrete dispensers. The flavor combination may include any number of individual flavorings that are included in the selected desired dispensers and that are mixed together to create the desired flavor combination. At least one discrete quantity of liquid flavoring is expelled from each of the desired dispensers into the mixing bottle. In the preferred embodiment of the present invention as shown in FIG. 13, a precision pump for each of the desired dispensers is actuated to expel the at least one discrete quantity of liquid flavoring. This allows a consistent and precise amount of the at least one discrete quantity of liquid flavoring to be expelled from the desired dispensers. The at least one discrete quantity of each liquid flavoring may be any volumetric quantity as desired. However, in the preferred embodiment of the present invention as shown in FIG. 3, each of the at least one discrete quantity of liquid flavoring is 0.5 milliliters (mL). However, this may vary based on the desired final volume of the vaping composition. Additionally, in the preferred embodiment of the present invention as shown in FIG. 4, a total volume of the at least one discrete quantity of liquid flavoring from each of the desired dispensers is 2 mL. Additionally, a total volume of the mixing bottle is 10 mL. The derived volume of the unmeasured quantity of liquid vaping base is 8 mL. This preferred embodiment of the present invention maintains the 1:4 volumetric concentration between flavoring and vaping base.

In addition to the at least one discrete quantity of liquid flavoring from each of the desired dispensers, an unmeasured quantity of liquid vaping base from the continuous dispenser is expelled into the mixing bottle. The unmeasured quantity of liquid vaping base is expelled until the unmeasured quantity of liquid vaping base and the at least one discrete quantity of liquid flavoring from each of the desired dispensers meet the volumetric concentration ratio between the flavoring and the vaping base. More specifically, the unmeasured quantity of liquid vaping base is expelled until the mixing bottle has been filled to capacity with the at least one discrete quantity of liquid flavoring from each of the desired dispensers and the unmeasured quantity of liquid vaping base. The mixing bottle is then agitated in order to form a homogeneous vaping composition between the unmeasured quantity of liquid vaping base and the at least one discrete quantity of liquid flavoring from each of the desired dispensers. The mixing bottle is agitated in order to thoroughly mix the vaping composition in preparation for vaporizing.

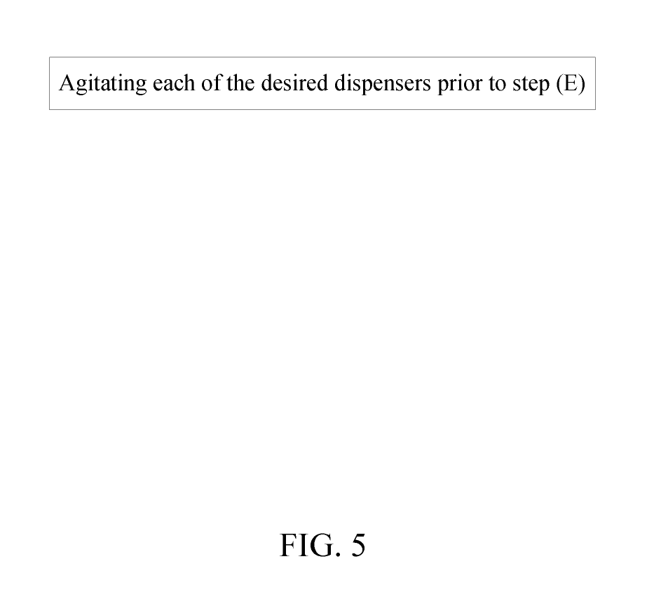

As shown in FIG. 5, each of the desired dispensers may be agitated immediately after designating the flavor combination by selecting desired dispensers from the plurality of discrete dispensers and prior to expelling the at least one discrete quantity of liquid flavoring from each of the desired dispensers into the mixing bottle. This allows the at least one discrete quantity of liquid flavoring from each of the desired dispensers to be thoroughly mixed for consistency of the at least one discrete quantity of liquid flavoring.

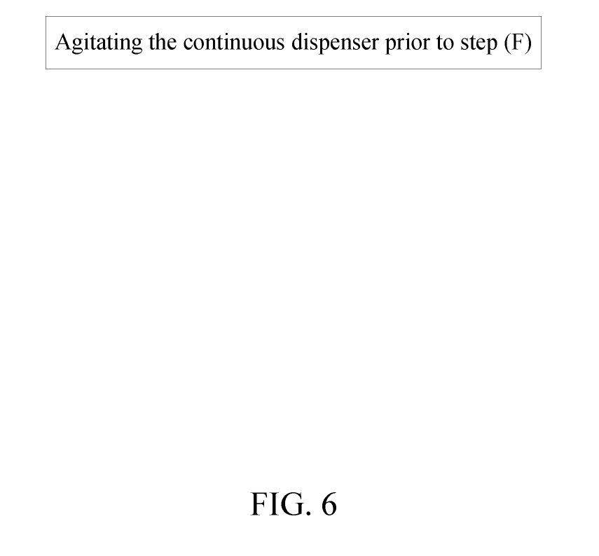

The continuous dispenser may be agitated prior to expelling the unmeasured quantity of liquid vaping base from the continuous dispenser into the mixing bottle as shown in FIG. 6. Similar to agitating each of the desired dispensers, agitating the continuous dispenser allows for the liquid vaping base to be thoroughly mixed for consistency of the unmeasured quantity of liquid vaping base.

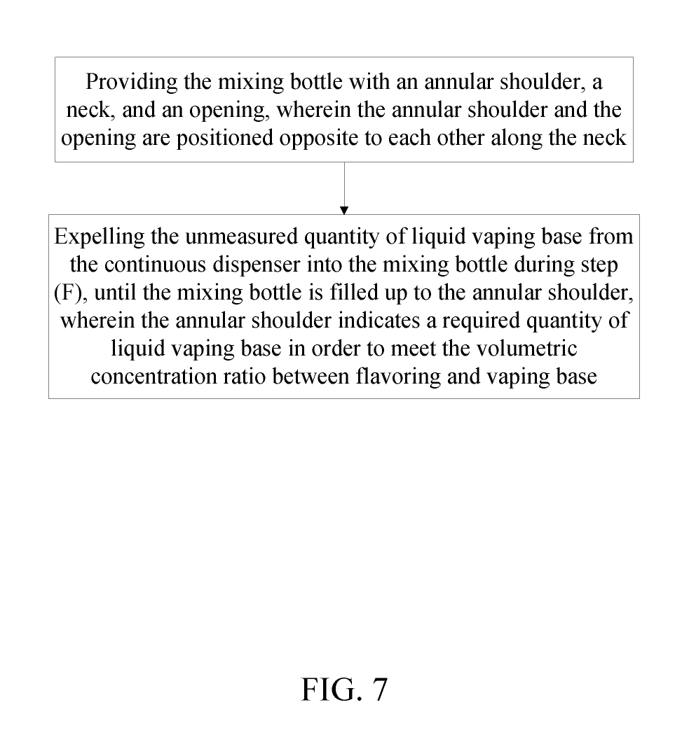

With reference to FIG. 7, the mixing bottle comprises an annular shoulder, a neck, and an opening. The annular shoulder and the opening are positioned opposite to each other along the neck. The unmeasured quantity of liquid vaping base is expelled from the continuous dispenser into the mixing bottle until the mixing bottle is filled up to the annular shoulder. The annular shoulder thus serves a visible indicator that the mixing bottle has been filled to capacity. Additionally, the annular shoulder indicates a required quantity of liquid vaping base in order to meet the volumetric concentration ratio between flavoring and vaping base. The at least one discrete quantity of liquid flavoring from each of the desired dispensers is expelled into the mixing bottle prior to the unmeasured quantity of liquid vaping base. As a result, the unmeasured quantity of liquid vaping base may be expelled into the mixing bottle up to the annular shoulder in order to meet the volumetric concentration ratio between flavoring and vaping base.

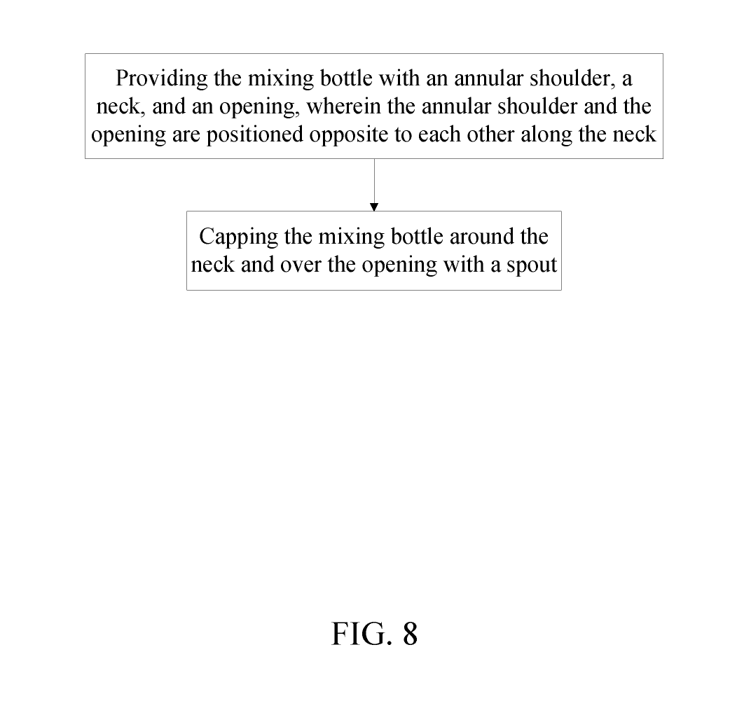

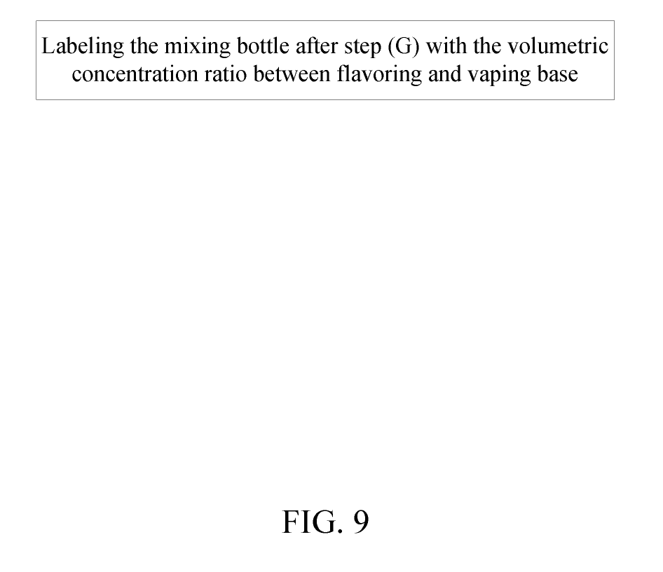

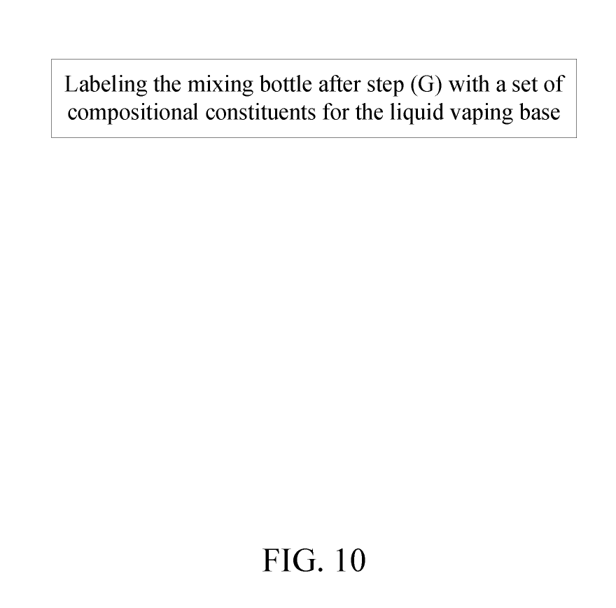

After the mixing process has been completed, the mixing bottle may then be capped around the neck and over the opening with a spout as shown in FIG. 8. The spout facilitates pouring of the vaping composition from the mixing bottle prior to vaporizing the vaping composition. The mixing bottle may then be labeled with the volumetric concentration ratio between flavoring and vaping base as shown in FIG. 9. The mixing bottle is labeled to allow for quick visual assessment of the contents of the mixing bottle. As shown in FIG. 10, the mixing bottle may additionally be labeled with a set of compositional constituents for the liquid vaping base. More specifically, the set of compositional constituents for the liquid vaping base includes, but is not limited to, PG and VG. The PG/VG ratio may be labeled on the mixing bottle for visual assessment of the PG/VG content.

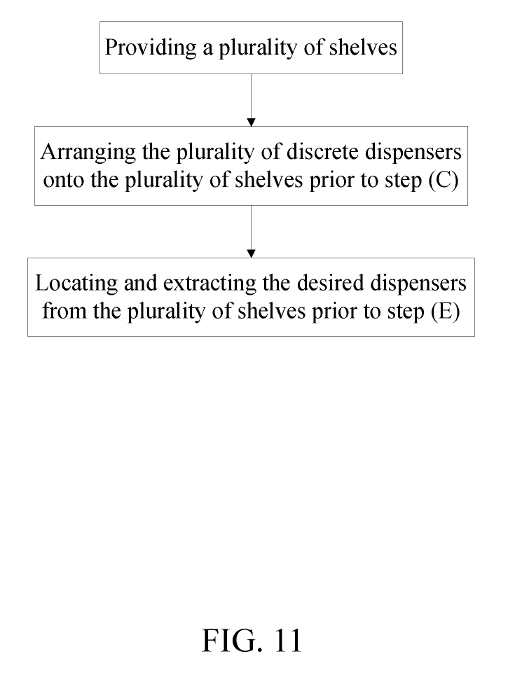

With reference to FIG. 11, in order to increase the efficiency of the mixing process, a plurality of shelves is provided for organizing the plurality of discrete dispensers. The plurality of discrete dispensers is arranged onto the plurality of shelves prior to designating the volumetric concentration ratio between flavoring and vaping base for the mixing bottle. The plurality of discrete dispensers is organized in a manner such that the desired dispensers from the plurality of discrete dispensers may be easily located and retrieved from the plurality of shelves. The desired dispensers from the plurality of shelves are located and extracted from the plurality of shelves prior to expelling the at least one discrete quantity of liquid flavoring from each of the desired dispensers into the mixing bottle. As a result, it is important that the plurality of discrete dispensers is organized on the plurality of shelves in a clear and organized manner.

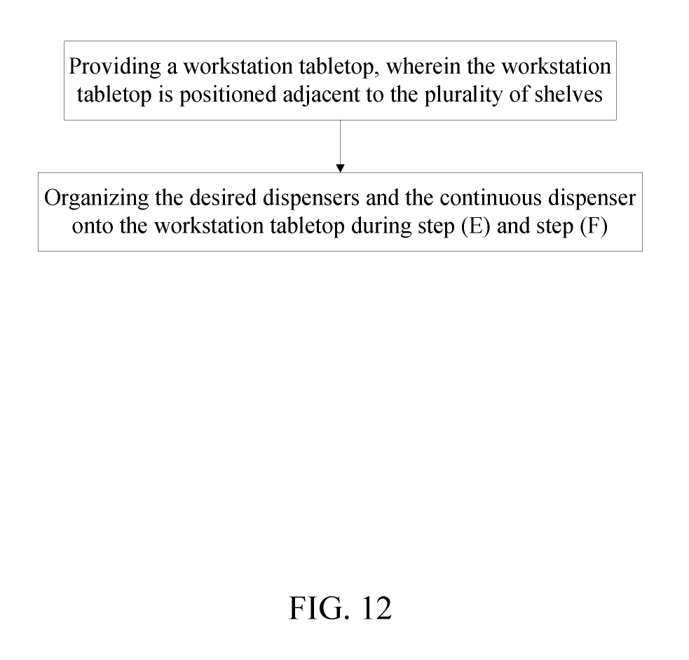

A workstation tabletop is provided for mixing the vaping composition as well as shown in FIG. 12. The workstation tabletop is positioned adjacent to the plurality of shelves and the desired dispensers from the plurality of shelves may be easily placed onto the workstation tabletop. The desired dispensers and the continuous dispenser are organized onto the workstation tabletop when the at least one discrete quantity of liquid flavoring from each of the desired dispensers and the unmeasured quantity of liquid vaping base from the continuous dispenser are expelled into the mixing bottle. The efficiency of the mixing process is improved by organizing the desired dispensers and the continuous dispenser onto the workstation tabletop during the mixing process.

An automated mixing machine may be utilized in order to mix and dispense the vaping composition. Functioning similar to a vending machine, the automated mixing machine comprises a housing with a container shelving assembly and a fluid transport system positioned within the housing. A physical user interface such as an audiovisual touchscreen is externally positioned on the housing to allow customers to input desired properties of the vaping composition. Alternatively, orders may be remotely placed via an application installed on an external computing device and then physically retrieved from the automated mixing machine. Additional media output devices such as speakers may be present on the automated mixing machine as well.

Vaping constituents are contained within containers that are arranged on the container shelving assembly within the housing. The containers are connected to the fluid transport system that draws the vaping constituents from the containers and deposits the vaping constituents into a mixing bottle. The fluid transport system may utilize one or more pumps in order to transport the vaping constituents from the containers and through the fluid transport system. Each container is connected to a dedicated conduit from the fluid transport system, allowing any combination of vaping constituents to be utilized and preventing any cross-contamination of flavors and other vaping constituents. Each container may be placed into a dedicated receptacle and connected to the fluid transport system via a mechanical engagement between the container and the fluid transport system. A plurality of tubes may be utilized to transport the vaping constituents within the containers through the fluid transport system. The automated mixing machine functions similarly to an assembly line in which the mixing bottle is automatically moved beneath the appropriate dispensing nozzles of the fluid transport system. The mixing bottle may be automatically sealed and actuated in order to mix the vaping constituents as well. The automated mixing machine may include a transparent window that allows outside visibility of the mixing process. After the vaping composition has been mixed, a printer may print an adhesive label for the mixing bottle detailing the vaping constituents.

The automated mixing machine may include software or a database of all flavors, vaping composition recipes, and user recommendations. The vaping constituents for the vaping composition may be selected directly through the software or database. The selected vaping constituents are then automatically selected and dispensed by the automated mixing machine. The software is responsible for ensuring that exact volumetric quantities of the vaping constituents are dispensed prior to mixing. Additionally, the software may be utilized to track available inventory of vaping constituents, transfer promotional data to customers, and process transactions made through the automated mixing machine.

Although the present invention has been explained in relation to its preferred embodiment, it is understood that many other possible modifications and variations can be made without departing from the spirit and scope of the present invention as hereinafter claimed.

What is claimed is:

1. A method of customizing a vaping composition comprises the steps of:
(A) providing a plurality of discrete dispensers, wherein each of the plurality of discrete dispensers retains a different kind of liquid flavoring;
(B) providing at least one continuous dispenser, wherein the continuous dispenser retains a liquid vaping base;
(C) designating a volumetric concentration ratio between flavoring and vaping base for the mixing bottle;
(D) designating a flavor combination by selecting desired dispensers from the plurality of discrete dispensers;
(E) expelling at least one discrete quantity of liquid flavoring from each of the desired dispensers into the mixing bottle;
(F) expelling an unmeasured quantity of liquid vaping base from the continuous dispenser into the mixing bottle, until the unmeasured quantity of liquid vaping base and the at least one discrete quantity of liquid flavoring from each of the desired dispensers meet the volumetric concentration ratio between the flavoring and the vaping base; and
(G) agitating the mixing bottle in order to form a homogeneous vaping composition between the unmeasured quantity of liquid vaping base and the at least one discrete quantity of liquid flavoring from each of the desired dispensers.

2. The method of customizing a vaping composition as claimed in claim 1, wherein the volumetric concentration ratio between flavoring and vaping base for the mixing bottle ranges from 1:3 to 1:4.

3. The method of customizing a vaping composition as claimed in claim 1, wherein each of the at least one discrete quantity of liquid flavoring is 0.5 milliliters (mL).

4. The method of customizing a vaping composition as claimed in claim 1, wherein:
a total volume of the at least one discrete quantity of liquid flavoring from each of the desired dispensers is 2 mL;
a total volume of the mixing bottle is 10 mL; and
a derived volume of the unmeasured quantity of liquid vaping base from the continuous dispenser is 8 mL.

5. The method of customizing a vaping composition as claimed in claim 1 comprises the step of:
agitating each of the desired dispensers prior to step (E).

6. The method of customizing a vaping composition as claimed in claim 1 comprises the step of:
agitating the continuous dispenser prior to step (F).

7. The method of customizing a vaping composition as claimed in claim 1 comprises the steps of:
providing the mixing bottle with an annular shoulder, a neck, and an opening, wherein the annular shoulder and the opening are positioned opposite to each other along the neck; and
expelling the unmeasured quantity of liquid vaping base from the continuous dispenser into the mixing bottle during step (F), until the mixing bottle is filled up to the annular shoulder, wherein the annular shoulder indicates a required quantity of liquid vaping base in order to meet the volumetric concentration ratio between flavoring and vaping base.

8. The method of customizing a vaping composition as claimed in claim 1 comprises the steps of:
providing the mixing bottle with an annular shoulder, a neck, and an opening, wherein the annular shoulder and the opening are positioned opposite to each other along the neck; and
capping the mixing bottle around the neck and over the opening with a spout.

9. The method of customizing a vaping composition as claimed in claim 1 comprises the step of:
labeling the mixing bottle after step (G) with the volumetric concentration ratio between flavoring and vaping base.

10. The method of customizing a vaping composition as claimed in claim 1 comprises the step of:
labeling the mixing bottle after step (G) with a set of compositional constituents for the liquid vaping base.

11. The method of customizing a vaping composition as claimed in claim 1 comprises the steps of:
providing a plurality of shelves;
arranging the plurality of discrete dispensers onto the plurality of shelves prior to step (C); and
locating and extracting the desired dispensers from the plurality of shelves prior to step (E).

12. The method of customizing a vaping composition as claimed in claim 11 comprises the steps of:
providing a workstation tabletop, wherein the workstation tabletop is positioned adjacent to the plurality of shelves; and
organizing the desired dispensers and the continuous dispenser onto the workstation tabletop during step (E) and step (F).

13. The method of customizing a vaping composition as claimed in claim 1, wherein a precision pump for each of the desired dispensers is actuated to expel the at least one discrete quantity of liquid flavoring.
